(19) United States
(12) Patent Application Publication
(10) Pub. No.: US 2005/0002199 A1
(43) Pub. Date: Jan. 6, 2005

(54) Loudspeaker unit with source of light

(75) Inventors: Werner Stuffle, Remseck (DE); Andreas Heim, Esslingen (DE); Joachim Kleine, Esslingen (DE)

Correspondence Address: Warn, Burgess & Hoffmann, P.C., P.O. Box 70098, Rochester Hills, MI, 48307, US

(73) Assignee: Reitter & Schefenacker Sound GmbH, Esslingen (DE)

(21) Appl. No.: 10/821,741

(22) Filed: Apr. 9, 2004

(30) Foreign Application Priority Data
Apr. 10, 2003 (DE) DE 103 16 678.5

(51) Int. Cl. H04R 5/02

(52) U.S. Cl. 362/487

(57) ABSTRACT

The invention relates to a loudspeaker unit of a motor vehicle, including at least one speaker with chassis and at least one light source. A light source is installed in the chassis of a speaker. By the present invention, a speaker unit has been developed, of compact construction and requiring little installation outlay.

### CROSS-REFERENCE TO RELATED APPLICATION

This application is a National Stage of German Patent Application No. DE 103 16 678.5, filed on Apr. 10, 2003. The disclosure of the above application is incorporated herein by reference.

### FIELD OF THE INVENTION

The present invention relates to a loudspeaker unit of a motor vehicle, including at least one speaker having a chassis and at least one light source.

### BACKGROUND AND SUMMARY OF THE INVENTION

DE 94 02 236 U1 discloses such a loudspeaker unit. The several components are accommodated in a housing, mounted on the tailgate. This unit occupies a great deal of space in the vehicle. Besides, installation involves a great outlay.

The present invention, then, is addressed to the problem of developing a loudspeaker unit of compact construction, requiring little installation outlay.

This problem is solved by the features of the principal claim. To that end, a light source is incorporated in the chassis of a speaker.

By the installation of one or more light sources in the chassis of the speaker, in each instance an electrical connection of the light source to the chassis of the speaker is made. Optionally, other electrical components may be interposed. The space required for the speaker unit is essentially determined by the outside dimensions of the speaker. The speaker unit thus has compact outside dimensions. For installation, the speaker unit is a preassembled group to be inserted as a whole in a recess, for example, in the inner trim of the vehicle. The installation outlay is, therefore, limited.

The electrical connections of the light sources may be laid on the connection bar of the speaker. The connection to the vehicle circuit can then be made with a single plug-in connection.

If an active loudspeaker is employed in the speaker unit, it will require an electrical connection to the direct-current network on board the motor vehicle. The current supply for the light source can then be carried by way of the same lines.

The speakers in the loudspeaker unit may be high-, medium-, low- or extremely low-pitch speakers, or combinations of such speakers.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of the loudspeaker unit with light sources arranged in an axial orientation;

FIG. 2 is a top view of the loudspeaker unit of FIG. 1 from the interior of the vehicle;

FIG. 3 is a sectional view of an alternate embodiment of a loudspeaker unit with light sources, arranged in the direction of the speaker drive;

FIG. 4 is a sectional view of an alternate embodiment of a loudspeaker unit with light sources arranged in radial directions;

FIG. 5 is a sectional view of an alternate embodiment of a loudspeaker unit with light source and a diffusion or dispersion disk following the latter; and

FIG. 6 is a top view of the loudspeaker unit of FIG. 5 from the interior of the vehicle.

### DETAILED DESCRIPTION OF THE PREFERRED EMBODIMENTS

The following description of the preferred embodiments is merely exemplary in nature and is in no way intended to limit the invention, its application, or uses.

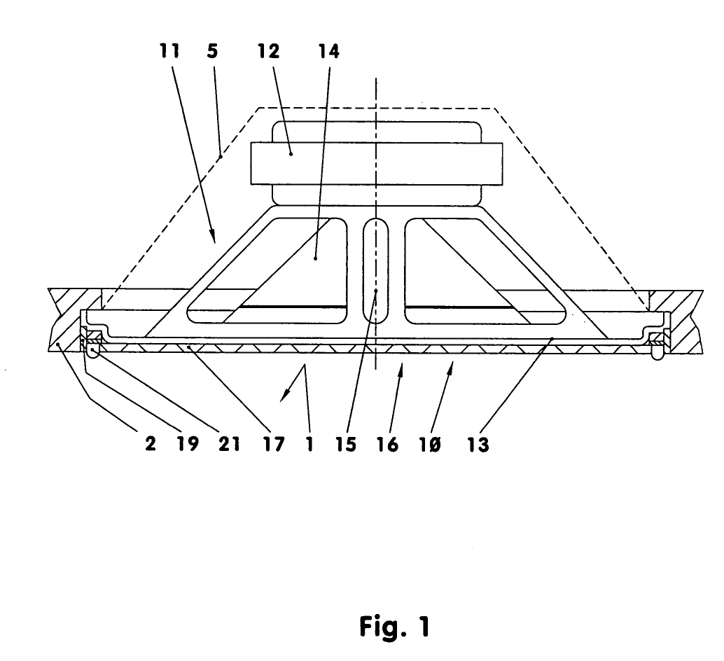

FIG. 1 shows a loudspeaker unit (10) of a motor vehicle, installed, for example, in the interior trim (2) of a vehicle top not shown. The speaker unit (10) comprises a speaker (11) consisting of at least one chassis (13), a diaphragm (14) and a drive (12). The diaphragm opening (16) points, for example, in the direction of the interior (1) of the vehicle.

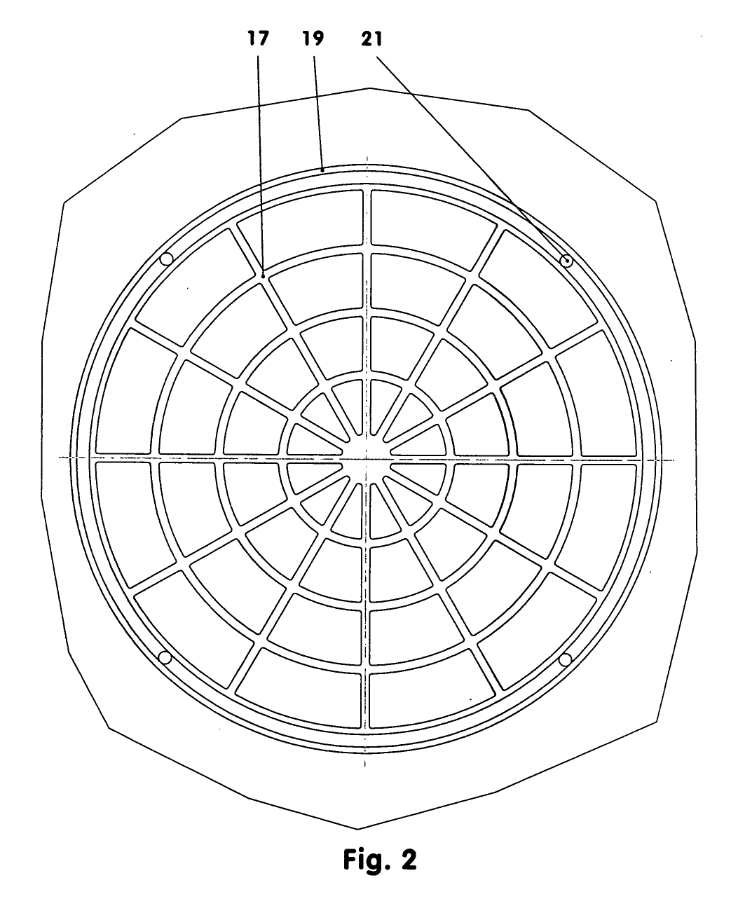

On the chassis (13) of the speaker (11), for example, four light sources (21) are installed, cf. FIG. 2. These light sources (21) are, for example, light-emitting diodes (21). They are soldered in place on the chassis (13) outside of the diaphragm opening (16), so that an electrical connection of each light-emitting diode (21) is electrically conductively connected to the chassis (13) of the speaker (11). The other electrical connection is, for example, connected by an electric cable to the electrical connection bar, here not shown, of the speaker (11).

The light-emitting diodes (21) point in the direction of the axis (15) of the speaker (11).

Over the diaphragm opening (16) is placed a protective grid (17), protecting the diaphragm (14) and the light-emitting diodes (21) from damage and bounding the speaker unit (10) from the interior (1) of the vehicle. A support ring (19) protects the light-emitting diode (21) during installation and during operation of the motor vehicle.

For pre-installation of the speaker unit (10), the light-emitting diodes (21) are fixed to the chassis (13) of the speaker (11) and an electrical connection of each light-emitting diode (21) is soldered to the chassis (13) of the speaker (11). The other connection is connected to the electric connection bar of the speaker (11) by means of a cable. Then the protective grid (17) and the support ring (19) are put in place.

The speaker unit (10) thus pre-installed, is placed in the interior trim (2) of the motor vehicle and, at the same time, the electrical connection to the vehicle circuit is made. Since both the electrical connections of the speaker (11) and the electrical connections of the light-emitting diodes (21) are on the connection bar of the speaker (11), the installation of the speaker unit (10) in the motor vehicle involves only a single electrical intersection with the vehicle circuit.

The space (5) required in the internal trim (2) of the motor vehicle for the speaker unit (10) is determined by the outside dimensions of the speaker (11). The light-emitting diodes (21) require no additional installation space (5) in the vehicle.

Instead of light-emitting diodes (21), incandescent bulbs or other luminous means may be employed as light sources (21).

FIG. 2 shows a top view of the speaker unit (10) from the interior (1) of the vehicle. The four luminescent diodes (21) are arranged on a common partial circle. The protective grid (17) may be open or closed, for example, by a sound-transmissive textile mat.

If the speaker units (10) are installed in the vehicle top, the light-emitting diodes (21) may, for example, be employed as interior lighting or as reading lights.

FIG. 3 shows a speaker unit (10) in which the light-emitting diodes (21) installed in the direction of the axis (15) of the speaker (11) point in the direction of the drive (12) of the speaker (11). Such a speaker unit (10) may, for example, be installed in the tailgate of a motor vehicle. The light sources (21) then serve, for example, as trunk space lighting. Also, individual components may be illuminated in the trunk as, for example, emergency equipment or a CD player. In the speaker unit (10), additional light sources (21) may be integrated, e.g. to make possible both the trunk lighting and the lighting of individual components in the trunk compartment.

The speaker unit (10) represented in FIG. 3 may include additional light sources (21) as well as the light sources (21) aforementioned, arranged as shown in FIGS. 1 and 2. The latter then serve, for example, for indirect lighting of the interior (1) of the vehicle.

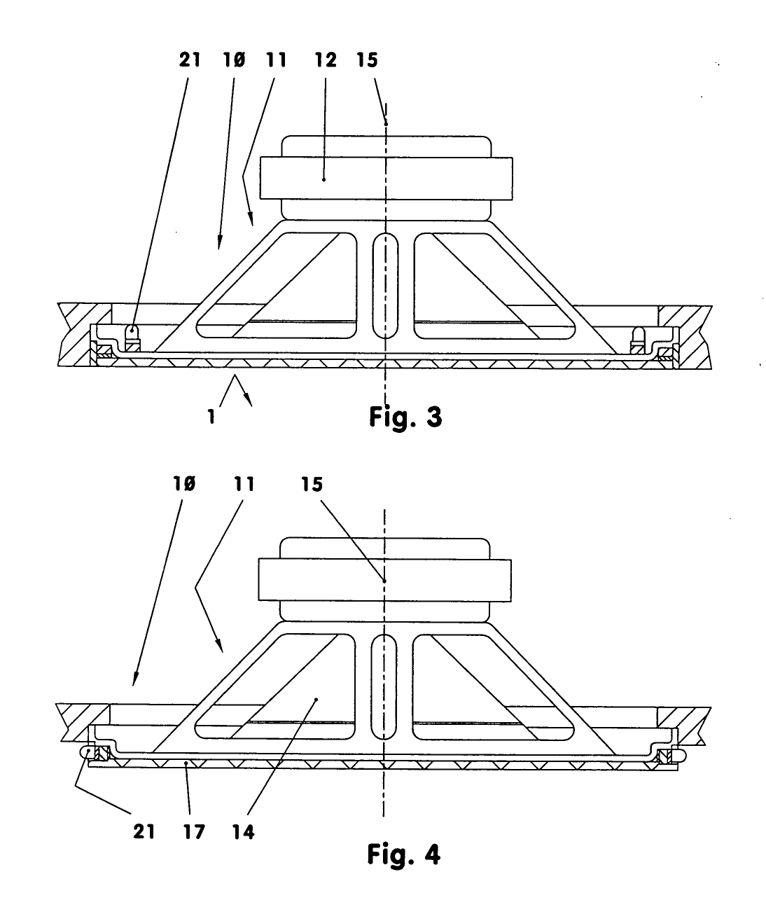

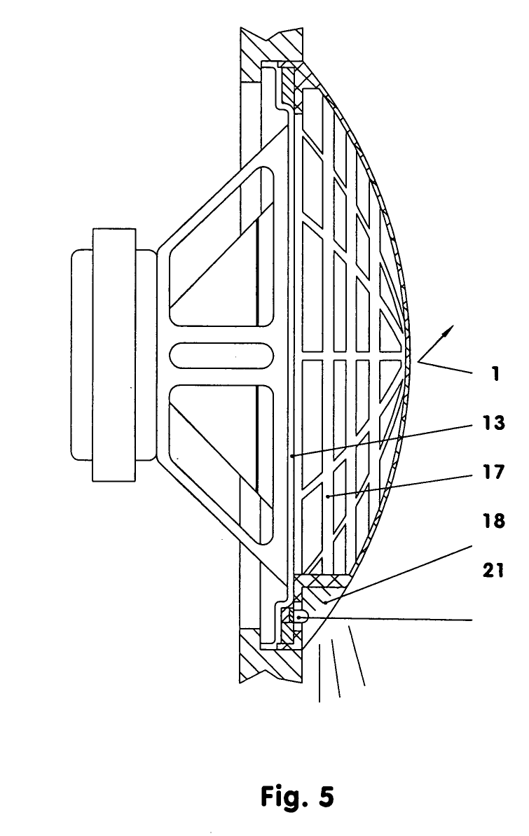

FIG. 4 shows a speaker unit (10) in which the light sources (21) are arranged radial to the direction of the axis (15) of the speaker (11). This speaker unit (10) is, for example, not flush with the interior trim (2), but projects beyond it in the direction of the interior (1) of the vehicle. The protective grid (17), here again, protects the diaphragm (14) of the speaker (11) and the light-emitting diodes (21) from damage.

This speaker unit (10) may, for example, be installed in a front or rear door of a motor vehicle. The light-emitting diodes (21) then serve e.g., as entrance and exit lighting. Of course, this speaker unit (10) may alternatively be combined with light sources (21), arranged as in FIGS. 1 to 3. Thus, for example, a combined exit and foot room lighting can be realized.

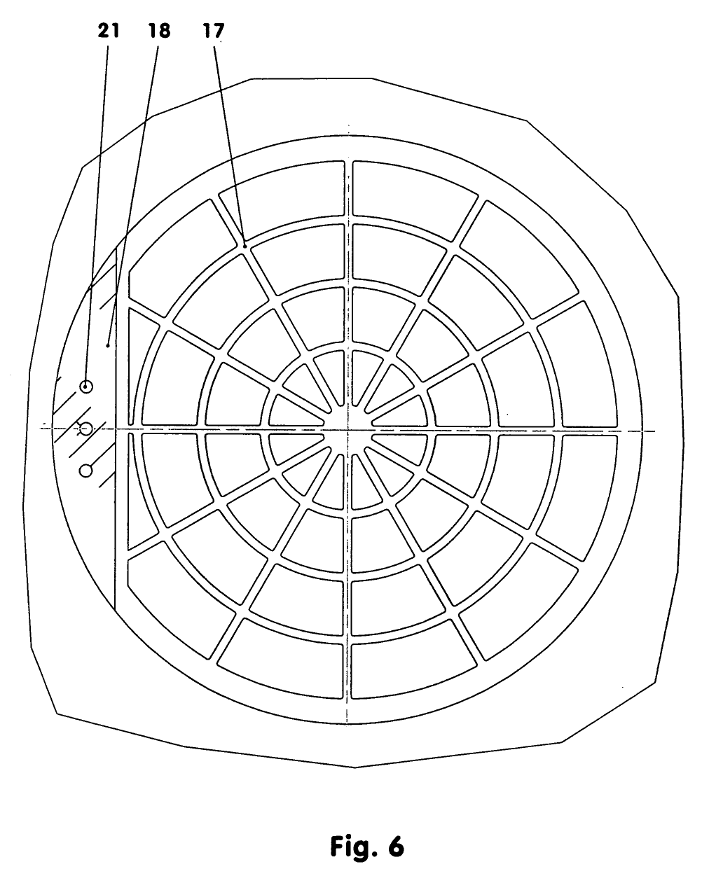

Another embodiment of a speaker unit (10) is shown by way of example in FIGS. 5 and 6. The speaker unit (10) is constructed much like the speaker units (10) shown in FIGS. 1 and 2. To the chassis (13) of the speaker (11), three light-emitting diodes (21) are fastened. The protective grid (17) is in the shape of a spherical segment. A transparent portion (18) of the protective grid (17) surrounds the light-emitting diodes (21). The transparent or light transmissive material portion (18) is placed adjacent the light-emitting diodes (21). The transparent portion (18) may, for example, include a disk bundling or scattering the light emitted by the light source (21) or otherwise diffusing or dispersing the light generated. The light source (21) of such a speaker unit (10) may, for example, be employed as interior lighting in the top of the interior (1) of the vehicle during installation. In the case of installation in a vehicle door, the light sources (21) serve, for example, as combined foot room and exit space lighting. Alternatively, they may, for example, be employed as door warning lights for open doors.

In the speaker units (10) shown in FIGS. 1 to 6, for example, switches may be installed as well, for example, to switch the light sources (21) on and off. Thus, such a speaker unit (10) may also be retro-installed in a motor vehicle without major installation or wiring outlay.

The description of the invention is merely exemplary in nature and, thus, variations that do not depart from the gist of the invention are intended to be within the scope of the invention. Such variations are not to be regarded as a departure from the spirit and scope of the invention.

1. A speaker unit for use in a motor vehicle, comprising:
at least one speaker having a chassis; and
at least one light source, said at least one light source being installed in the chassis of a speaker.

2. The speaker unit according to claim 1, wherein the light source is screwed into the chassis.

3. The speaker unit according to claim 1, wherein the light source is soldered into the chassis.

4. The speaker unit according to claim 1, further comprising a single electrical intersection with the vehicle circuit.

5. The speaker unit according to claim 1, wherein the light source is arranged parallel to the axis of a speaker.

6. The speaker unit according to claim 1, wherein the light source is arranged perpendicular to the axis of a speaker.

7. The speaker unit according to claim 1, wherein said at least one light source is followed by a dispersion disk.

8. The speaker unit according to claim 1, wherein said at least one light source is a light-emitting diode.

9. The speaker unit according to claim 8, further comprising a light transmissive material adjacent the light emitting diode for allowing light to be dispersed into the interior of a vehicle.

10. The speaker unit according to claim 9, wherein the light-emitting diode and light transmissive material form one component.
